(19) United States
(12) Patent Application Publication
(10) Pub. No.: US 2012/0154864 A1
(43) Pub. Date: Jun. 21, 2012

(54) IMAGE FORMING APPARATUS

(75) Inventor: Hiroyuki ARAI, Tokyo (JP)

(73) Assignee: KONICA MINOLTA BUSINESS TECHNOLOGIES, INC., Tokyo (JP)

(21) Appl. No.: 13/326,591

(22) Filed: Dec. 15, 2011

(30) Foreign Application Priority Data
Dec. 16, 2010 (JP) 2010-280408

(51) Int. Cl. G06K 15/02

(52) U.S. Cl. 358/1.15

(57) ABSTRACT

An image forming apparatus includes: a first image forming unit provided at a first stage for executing a print process to a single-side of a sheet, including a first feeding tray; and a second image forming unit provided at a next stage for executing a print process to a single-side of a sheet, including a second feeding tray. These units are connected in series so as to execute single-side or both-sides print process. The apparatus further including a control section which, when a first print process for the sheet fed from the first feeding tray and a second print process for the sheet fed from the second feeding tray are switched based upon print instruction information so as to execute the switched print process, controls an operation state of the first image forming unit depending on an execution condition of the second print process.

### BACKGROUND

1. Field of the Invention

The present invention relates to an image forming apparatus.

2. Description of Related Art

There has conventionally been known an image forming apparatus having a tandem configuration in which two image forming units are connected in series, which units can execute a print process on a single side of a sheet. The image forming apparatus described above can make a single-side print process in which a print process is executed only to a single side of a sheet by either one of the image forming unit at a first stage or the image forming unit at a next stage, and a double-side print process in which a print process is executed to the single side of a sheet by the image forming unit at the first stage, and then the print process is executed to the reverse side of the sheet by the image forming unit at the next stage. In the image forming apparatus described above, the sheet is fed from a feeding tray provided in the image forming unit at the first stage when the single-side print process is executed. Therefore, even in the single-side print process, the image forming unit at the first stage has to be driven, which causes unnecessary material deterioration of the image forming unit at the first stage and power consumption.

In view of this, there has been known an image forming apparatus having the tandem configuration in which the image forming unit at the next stage has a feeding tray (e.g., see Japanese Patent Application Laid-Open Publication No. Hei10-86455, and Japanese Patent Application Laid-Open Publication No. 2005-22243). According to the image forming apparatus described in Japanese Patent Application Laid-Open Publication No. Hei10-86455 and Japanese Patent Application Laid-Open Publication No. 2005-22243, a sheet can be fed from the feeding tray provided in the image forming unit at the next stage, when the single-side print process is executed. Therefore, the image forming unit at the first stage can be stopped.

There has also been known an image forming apparatus in which a feeding tray is provided in the image forming unit at the next stage, wherein the single-side print process can be executed between arbitrary pages during execution of the double-side print process, and the sheet to which the single-side print process has been performed can join the sheets, to which the double-side print process is to be performed, with an appropriate interval (e.g., see Japanese Patent Application Laid-Open Publication No. Hei8-319051).

According to the image forming apparatus described in Japanese Patent Application Laid-Open Publication No. Hei8-319051, the single-side print process can be executed during the execution of the double-side print process. Therefore, even if print instruction information such as a print job includes both an instruction that the double-side print process should be executed to a certain sheet and an instruction that the single-side print process should be executed to another sheet (mixed job), the image forming apparatus can switch a pattern for executing the print process to the sheet fed from the feeding tray provided in the image forming unit at the next stage and a pattern for executing the print process to the sheet fed from the feeding tray provided in the image forming unit at the first stage to execute the pattern, thereby being capable of executing the print processes according to both of the instructions at a time.

However, with the image forming apparatus described in Japanese Patent Application Laid-Open Publication No. 8-319051, the operation state (driven state or stopped state) of the image forming unit at the first stage is not considered, when switching the pattern in which the print process is executed to the sheet fed from the feeding tray provided in the image forming unit at the next stage and the pattern in which the print process is executed to the sheet fed from the feeding tray provided in the image forming unit at the first stage to execute the pattern, with respect to the mixed job. Specifically, even when the print process is executed to the sheet fed from the feeding tray provided in the image forming unit at the next stage, the image forming unit at the first stage is always driven, which might still cause unnecessary material deterioration of the image forming unit at the first stage and power consumption.

### SUMMARY

The object of the present invention is to provide an image forming apparatus which can control an operation of an image forming unit at a first stage, when switching a pattern in which a print process is executed to a sheet fed from a feeding tray provided in the image forming unit at the first stage and a pattern in which a print process is executed to a sheet fed from a feeding tray provided in an image forming unit at a next stage to execute a print process based upon print instruction information, whereby a material deterioration of the image forming unit at the first stage is prevented, and the power consumption of the image forming apparatus can be suppressed.

In order to achieve the abovementioned object, according to one aspect of the present invention, there is provided an image forming apparatus including: a first image forming unit provided at a first stage for executing a print process to a single-side of a sheet, the first image forming unit including a first feeding tray for feeding a sheet; and a second image forming unit provided at a next stage for executing a print process to a single-side of a sheet, the second image forming unit including a second feeding tray for feeding a sheet, and the first and second image forming units being connected in series so as to execute a print process on the single-side or a both-sides of the sheet, wherein the image forming apparatus further including a control section which is adapted to, when a first print process with respect to the sheet fed from the first feeding tray and a second print process with respect to the sheet fed from the second feeding tray are switched based upon print instruction information for instructing execution of the print process on the single-side or the both-sides for each sheet to be printed so as to execute the switched print process, control an operation state of the first image forming unit depending on an execution condition of the second print process.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is an overall diagram of an image forming apparatus according to a first embodiment;

FIG. 2 is a diagram schematically illustrating an internal structure of the image forming apparatus in FIG. 1, wherein a finishing unit is not-shown;

FIG. 3 is a block diagram illustrating a control structure of the image forming apparatus in FIG. 1;

FIG. 4 is a diagram for describing a path through which a sheet to be printed passes and a direction of the sheet to be printed in the image forming apparatus in FIG. 2, when a sheet to be printed includes only a sheet for single-side printing;

FIG. 5 is a diagram for explaining a path through which a sheet to be printed passes and a direction of the sheet to be printed in the image forming apparatus in FIG. 2, when a sheet to be printed includes only a sheet for both-side printing;

FIG. 6 is a diagram for explaining a path through which a sheet to be printed passes and a direction of the sheet to be printed in the image forming apparatus in FIG. 2, when sheets to be printed include a sheet for single-side printing and a sheet for both-side printing;

FIG. 7 is a time chart for explaining temporal changes in operation states of a first image forming unit and a second image forming unit and execution condition of sheets to be printed for a print process, when the image forming apparatus according to the first embodiment executes a mixed print process;

FIG. 8 is a time chart for explaining temporal changes in operation states of a first image forming unit and a second image forming unit and execution condition of sheets to be printed for a print process, when a no-sheet state is detected during execution of the mixed print process by the image forming apparatus according to the first embodiment;

FIG. 9 is a diagram for explaining a path through which the sheet to be printed passes and the direction of the sheet to be printed in the image forming apparatus in FIG. 2, when the no-sheet state is detected during the execution of the mixed print process by the image forming apparatus according to the first embodiment;

FIG. 10 is a flowchart for explaining the print process executed by the image forming apparatus according to the first embodiment;

FIG. 11 is a flowchart for explaining the print process executed by the image forming apparatus according to the first embodiment;

FIG. 12 is a flowchart for explaining the print process executed by the image forming apparatus according to the first embodiment;

FIG. 13 is a flowchart for explaining a feeding timing setting process for a first image forming unit 100 executed by the image forming apparatus according to the first embodiment; and

FIG. 14 is a flowchart for explaining a feeding timing setting process for a second image forming unit 200 executed by the image forming apparatus according to the first embodiment.

### DETAILED DESCRIPTION OF THE PREFERRED EMBODIMENT

An Embodiment of an image forming apparatus according to the present invention will be described with reference to the drawings.

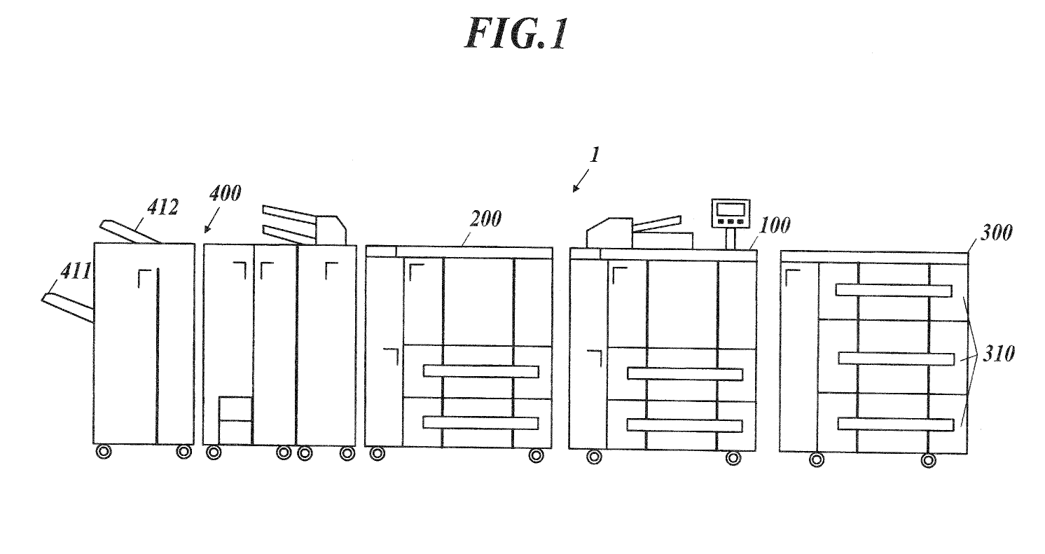

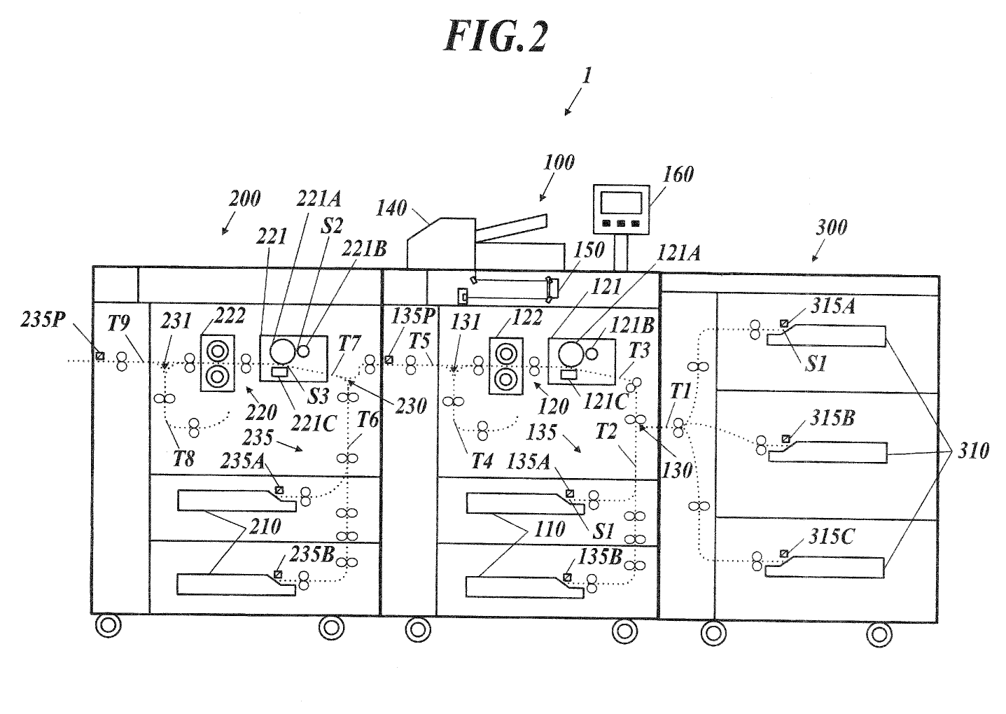

An image forming apparatus 1 is a copying machine or the like, which is a tandem-type image forming apparatus including a feeding unit 300, a first image forming unit 100 at a first stage, a second image forming unit 200 at a next stage, and a finishing unit 400, those of which are connected in serial, as illustrated in FIGS. 1 and 2.

The image forming apparatus 1 executes a print process to a sheet, which is fed from feeding trays provided in the feeding unit 300, the first image forming unit 100, and the second image forming unit 200, by the first image forming unit 100 or the second image forming unit 200, executes a finishing process to the sheet by the finishing unit 400, and then outputs the resultant sheet.

As illustrated in FIG. 2, the feeding unit 300 includes feeding unit trays 310, feeding unit sensors 315A-315C, and a conveyance path T1.

The feeding unit trays 310 house standard sheets or non-standard sheets, which are identified based upon a basis weight or size of a sheet, by each type set in advance. The sheets housed in the feeding unit trays 310 are fed to the first image forming unit 100 via the conveyance path T1 by a conveying roller. As illustrated in FIG. 2, a position where a feed of a sheet is started from any one of the feeding unit trays 310 (or later-described as first feeding trays 110 of the first image forming unit 100) is defined as S1.

The feeding unit sensor 315 is provided in the vicinity of a position where a sheet in each of the feeding unit trays 310 is conveyed, and outputs a detection signal when the sheet passes through this position.

As illustrated in FIG. 2, the first image forming unit 100 includes first feeding trays 110, a first image forming section 120, first conveyance path switching sections 130 and 131, a first sheet detecting sensor section 135, an automatic document feeder (ADF) 140, a scanner 150, a display operation section 160, conveyance paths T2, T3, and T5, and an inverse conveyance path T4.

The first feeding trays 110 house standard sheets or non-standard sheets, which are identified based upon a basis weight or size of a sheet, by each type set in advance. The sheet housed in the first feeding tray 110 is conveyed to the conveyance path T3 from the conveyance path T2 by the conveying roller.

The first image forming section 120 performs an electrophotographic image formation to a single-side of the sheet. The first image forming section 120 includes a transfer section 121 provided with a photosensitive drum 121A, a developing roller 121B, a transfer roller 121C, a laser unit and the like, and a fixing section 122 provided with a heat roller, pressure roller, and the like. The first image forming section 120 forms a toner image on a peripheral surface of the photosensitive drum 121A based upon inputted image data. The first image forming section 120 then transfers the toner image formed on the photosensitive drum 121A on the sheet, which is conveyed to the conveyance path T3 through the conveyance path T1 or the conveyance path T2, by the transfer roller 121C. The first image forming section 120 fixes the toner image, transferred on the sheet, by the fixing section 122 so as to form an image on the sheet.

The conveyance path switching section 130 switches the conveyance paths in such a manner that either one of the sheet fed into the conveyance path switching section 130 via the conveyance path T1 and the sheet fed into the conveyance path switching section 130 via the conveyance path T2 is conveyed to the conveyance path T3.

The conveyance path switching section 131 switches whether the sheet fed into the conveyance path switching section 131 via the conveyance path T3 is conveyed to the conveyance path T5 through the inverse conveyance path T4 or is conveyed to the conveyance path T5 without passing through the inverse conveyance path T4. When the sheet passes through the inverse conveyance path T4, the sheet is turned over by the inverse conveyance path T4, and with this state, it is conveyed to the conveyance path T5. It may naturally be configured such that the sheet conveyed to the inverse conveyance path T4 is again conveyed to the transfer section 121 with the faces thereof being turned over so as to form an image on a reverse side of the sheet.

The first sheet detecting sensor section 135 includes a plurality of first sheet detecting sensors 135A and 135B, and a first sheet discharge sensor 135P.

The first sheet detecting sensors 135A and 135B, and the first sheet discharge sensor 135P are provided along the conveyance paths of the sheet in the first image forming unit 100. When the sheet passes near the positions where the respective sensors are provided, the sensors output a detection signal. The first sheet discharge sensor 135P is provided at a position where the sheet is discharged to the outside of the first image forming unit 100 (at a position in the vicinity of the boundary between the first image forming unit 100 and the second image forming unit 200), and detects a discharge state of the sheet from the first image forming unit 100.

The ADF 140 automatically conveys documents stacked on a tray for stacking documents, one by one, to the scanner 150 from the uppermost one.

The scanner 150 reads the document conveyed by the ADF 140. Specifically, the scanner 150 scans the document with light emitted from a light source, images the reflection light by a charge coupled device (CCD), and performs a photoelectric conversion. The scanner 150 then acquires a document image from the document read through the photoelectric conversion.

The display operation section 160 includes a liquid crystal display (LCD), a touch panel provided to cover the LCD, an operation key group having various operation keys or operation buttons, and the like. The display operation section 160 displays various operation screens and various process results on the LCD according to an instruction from a later-described tandem system management section. When a user operates the touch panel or the operation key group, the display operation section 160 outputs various operation signals according to the operation to the tandem system management section.

As illustrated in FIG. 2, the second image forming unit 200 includes second feeding trays 210, a second image forming section 220, second conveyance path switching sections 230 and 231, a second sheet detecting sensor section 235, conveyance paths T6, T7, and T9, and an inverse conveyance path T8.

The second feeding trays 210 have the function and configuration same as those of the first feeding trays 110; the second image forming section 220 has the function and configuration same as those of the first image forming section 120; the second conveyance path switching sections 230 and 231 have the function and configuration same as those of the first conveyance path switching sections 130 and 131; the second sheet detecting sensor section 235 has the function and configuration same as those of the first sheet detecting sensor section 135; the conveyance paths T6, T7, and T9 have the function and configuration same as those of the conveyance paths T2, T3, and T5; and the inverse conveyance path T8 has the function and configuration same as those of the inverse conveyance path T4. Therefore, the description thereof will not be repeated.

As illustrated in FIG. 2, a writing position where an image is written on the peripheral surface of the photosensitive drum 221A in the second image forming section 220 is defined as S2, and a transfer position where the toner image formed on the photosensitive drum 221A is transferred on a sheet by the transfer roller 221C is defined as S3.

The finishing unit 400 executes predetermined finishing processes to the sheet conveyed through the conveyance path T9, when required. The finishing processes executed by the finishing unit 400 include a sorting process, a cutting process, a punching process, a stapling process, and the like. One or a plurality of finishing units 400 which are connected in series are provided according to process contents desired by the user. The sheet conveyed to the finishing unit 400 is discharged on a first sheet discharge tray 411 or a second sheet discharge tray 412 provided to the finishing unit 400.

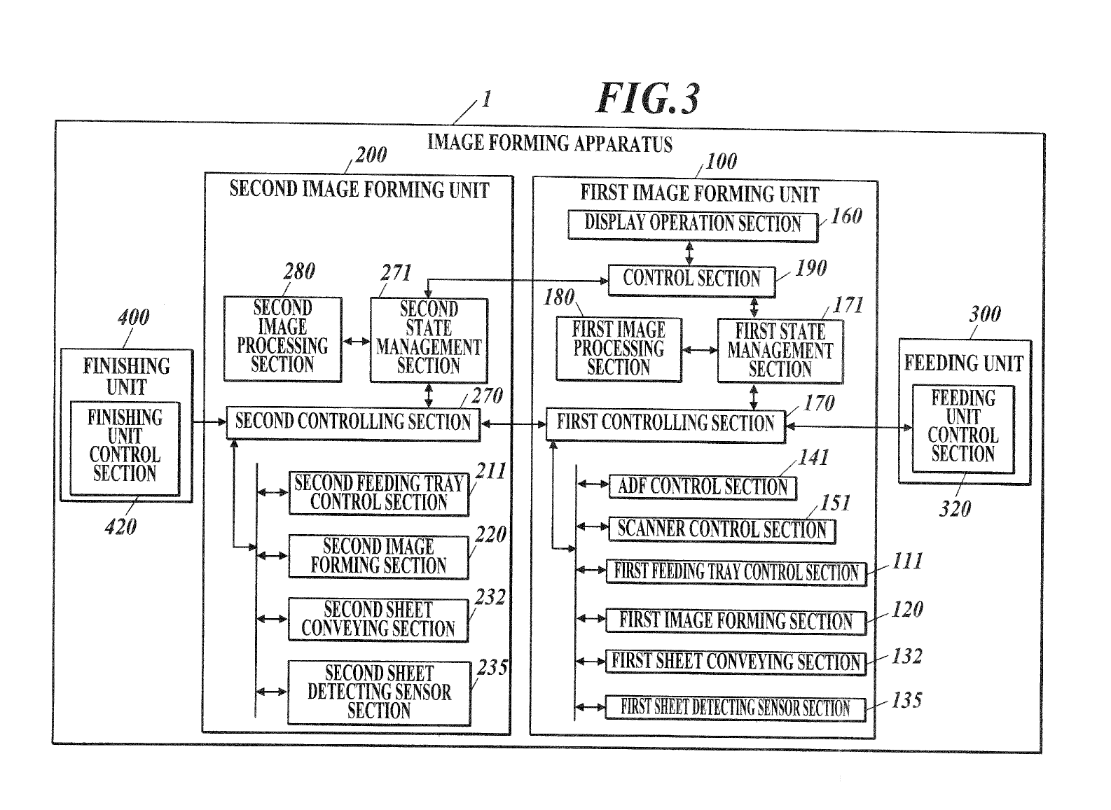

A functional configuration of the image forming apparatus 1 will be described with reference to a block diagram illustrated in FIG. 3.

As illustrated in FIG. 3, the image forming apparatus 1 includes the feeding unit 300, the first image forming unit 100, the second image forming unit 200, and the finishing unit 400. They are configured such that data can be transmitted and received among the respective units with a serial communication and the like.

The feeding unit 300 includes a feeding unit control section 320. The feeding unit control section 320 feeds a sheet from one of the feeding unit trays 310, and conveys the sheet to the first image forming unit 100 via the conveyance path T1.

The first image forming unit 100 includes an ADF control section 141, a scanner control section 151, the first image forming section 120, a first sheet conveying section 132, the first sheet detecting sensor section 135, a first feeding tray control section 111, a first controlling section 170, a first state management section 171, a first image processing section 180, and a control section 190.

The ADF control section 141 drives and controls the ADF 140, when a document is placed on the ADF 140. The scanner control section 151 reads an image of the document by the scanner 150. The first feeding tray control section 111 makes a control to feed a sheet from one of the first feeding trays 110 under the instruction from the first controlling section 170.

The first sheet conveying section 132 makes a control to convey either one of the sheet fed from the first feeding tray 110 (the sheet through the conveyance path T2) and the sheet fed from the feeding unit 300 (the sheet through the conveyance path T1) to the conveyance path T3 by the conveyance path switching section 130 under the instruction from the first controlling section 170. The first sheet conveying section 132 also makes a control, through the conveyance path switching section 131, for switching whether the sheet fed into the conveyance path switching section 131 via the conveyance path T3 is conveyed to the conveyance path T5 through the inverse conveyance path T4 or is conveyed to the conveyance path T5 without passing through the inverse conveyance path T4.

The display operation section 160 includes the LCD, the touch panel provided to cover the LCD, the operation key group having various operation keys or operation buttons, and the like. The display operation section 160 displays various operation screens and various process results on the LCD according to the instruction from the control section 190. When a user operates the touch panel or the operation key group, the display operation section 160 outputs various operation signals according to the operation to the control section 190. Specifically, when the user performs an operation to instruct the control section 190 to execute the print process to the document placed on the ADF 140, the display operation section 160 outputs an operation signal based upon the instruction to the control section 190 as print instruction information.

The first controlling section 170 controls the ADF control section 141, the scanner control section 151, the first feeding tray control section 111, the first image forming section 120, the first sheet conveying section 132, the first detecting sensor section 135, and the like, according to the instruction signal transmitted from the first state management section 171.

The first state management section 171 includes a central processing unit (CPU), a random access memory (RAM), and a read only memory (ROM). The first state management section 171 entirely manages (controls) the operation of the first image forming unit 100 in such a manner that the CPU reads various programs housed in the ROM, expands the same in the RAM, and executes the expanded various programs, according to the instruction signal transmitted from the control section 190.

The first image processing section 180 executes various image processes, and generates print image data, in accordance with the instruction signal transmitted from the first state management section 171. For example, the first image processing section 180 performs an image process, such as a raster image processor (RIP), based upon a print job transmitted from a personal computer (PC) connected to the first image forming unit 100 via a local area network (LAN), and generates the print image data. The first image processing section 180 generates the print image data based upon the image of the document read by the scanner 150 through the user's operation on the display operation section 160.

The first state management section 171 transmits the print image data generated by the first image processing section 180 to the first controlling section 170 so as to form an image based upon the image data on a sheet.

The control section 190 includes a CPU, an RAM, and an

ROM. The control section 190 allows the CPU to read the various programs stored in the ROM, to expand the read programs in the RAM, and to execute the expanded programs, thereby controlling the whole operation of the first image forming apparatus 1. Specifically, when the CPU executes the various programs, the control section 190 transmits various instruction signals to the first state management section 171, the second state management unit 271 of the second image forming unit 200, the feeding unit control section 320 of the feeding unit 300, and the finishing unit control section 410 of the finishing unit 400 so as to entirely control the respective units in the tandem system.

Specifically, when acquiring, as print instruction information, operation signals based upon an instruction of executing a print job transmitted from the PC through the LAN and a print process issued by a user through the display operation section 160, the control section 190 executes a print process based upon the print instruction information. The print instruction information includes information involved with the instruction whether a single-side print process should be performed or a double-side print process should be performed, for each of sheets which are subjects to be printed (sheet to be printed).

The single-side print process (second print process) indicates that the second image forming unit 200 executes the print process to the sheet (sheet for single-side printing) fed from the second feeding tray 210 of the second image forming unit 200 under the control of the control section 190. The double-side print process (first print process) indicates that each of the first image forming unit 100 and the second image forming unit 200 executes the print process to a single-side of a sheet (sheet for both-side printing) fed from the first feeding tray 110 of the first image forming unit 100 (or the feeding tray 310 of the feeding tray 300) under the control of the control section 190. The detail of the single-side print process and the double-side print process will be described in detail later.

The second image forming unit 200 includes the second image forming section 220, a second sheet conveying section 232, the second sheet detecting sensor section 235, a second feeding tray control section 211, a second controlling section 270, a second state management section 271, and a second image processing section 280.

The second image forming section 220 has the function and configuration same as those of the first image forming section 120; the second sheet conveying section 232 has the function and configuration same as those of the first sheet conveying section 132; the second sheet detecting sensor section 235 has the function and configuration same as those of the first sheet detecting sensor section 135; the second feeding tray control section 211 has the function and configuration same as those of the first feeding tray control section 111; the second controlling section 270 has the function and configuration same those of the first controlling section 170; the second state management section 271 has the function and configuration same as those of the first state management section 171; and the second image processing section 280 has the function and configuration same as those of the first image processing section 180. Therefore, the description thereof will not be repeated.

The finishing unit 400 includes the finishing unit control section 410. The feeding unit control section 410 controls to execute a necessary finishing process to a sheet fed through the conveyance path T9 according to the instruction signal transmitted from the control section 190.

### [Print Process]

The print process executed by the control section 190 will be described.

### (Case Where Sheet to be Printed is Only Sheet for Single-Side Printing)

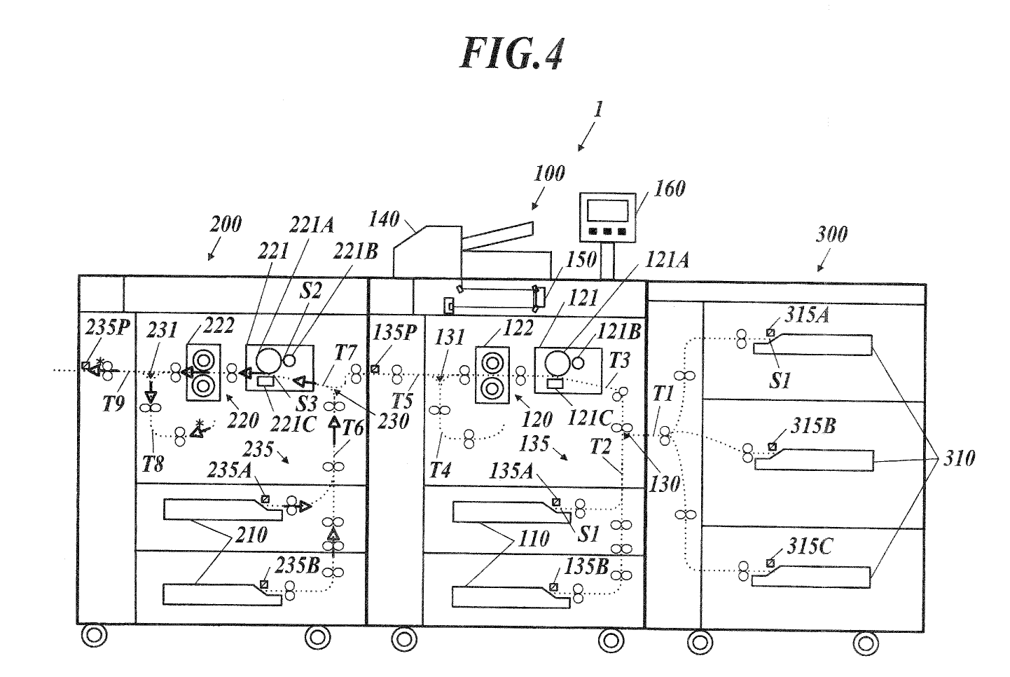

When the control section 190 determines that all sheets to be printed are sheets for single-side printing based upon the acquired print instruction information, it executes a single-side print process illustrated in FIG. 4. Outlined arrows in FIG. 4 indicate a conveying direction of a sheet in the single-side print process. Arrows with * out of the outlined arrows schematically indicate that the back surface of the sheet directs upward.

Specifically, the control section 190 feeds a sheet from one of the second feeding trays 210 as illustrated in FIG. 4. In this case, the control section 190 switches, via the second sheet conveying section 232, the conveyance path switching section 230 in order that the sheet through the conveyance path T6 is conveyed to the conveyance path T7. Similarly, the control section 190 switches, via the second sheet conveying section 232, the conveyance path switching section 231 in order that the sheet fed into the conveyance path switching section 231 through the conveyance path T7 is conveyed to the conveyance path T9 via the inverse conveyance path T8.

Next, the control section 190 forms an image based upon the image data generated by the second image processing section 280 on the front surface of the sheet fed into the conveyance path T7 by the second image forming section 220. Then, the control section 190 conveys the sheet, having the image formed thereon, to the inverse conveyance path T8. Specifically, the control section 190 turns over the sheet in order that the sheet is conveyed to the conveyance path T9 with the back surface of the sheet directing upward.

The control section 190 conveys the sheet to the finishing unit 400 via the conveyance path T9, executes required finishing processes, and then discharges the resultant sheet on the sheet discharge tray 411.

The control section 190 may naturally execute the single-side print process based upon the sheet fed from one of the first feeding trays 110 and the feeding unit trays 310. In this case, the control section 190 conveys the sheet, which is conveyed through the conveyance path T1 or the conveyance path T2, to the conveyance path T3 by the first sheet conveying section 132. Then, the control section 190 forms an image based upon the image data generated by the first image processing section 180, on the front surface of the sheet, by the first image forming section 120. Next, the control section 190 conveys the sheet, having the image formed thereon, to the inverse conveyance path T4 so as to turn over the sheet. The control section 190 then conveys the sheet to the second image forming unit 200 through the conveyance path T5. The control section 190 then conveys the sheet to the finishing unit 400 without forming an image on the sheet by the second image forming section 220 and without turning over the sheet by the inverse conveyance path T8, executes required finishing processes to the sheet, and then, discharges the sheet on the sheet discharge tray 411.

### (Case Where Sheet to be Printed is Only Sheet for Both-Side Printing)

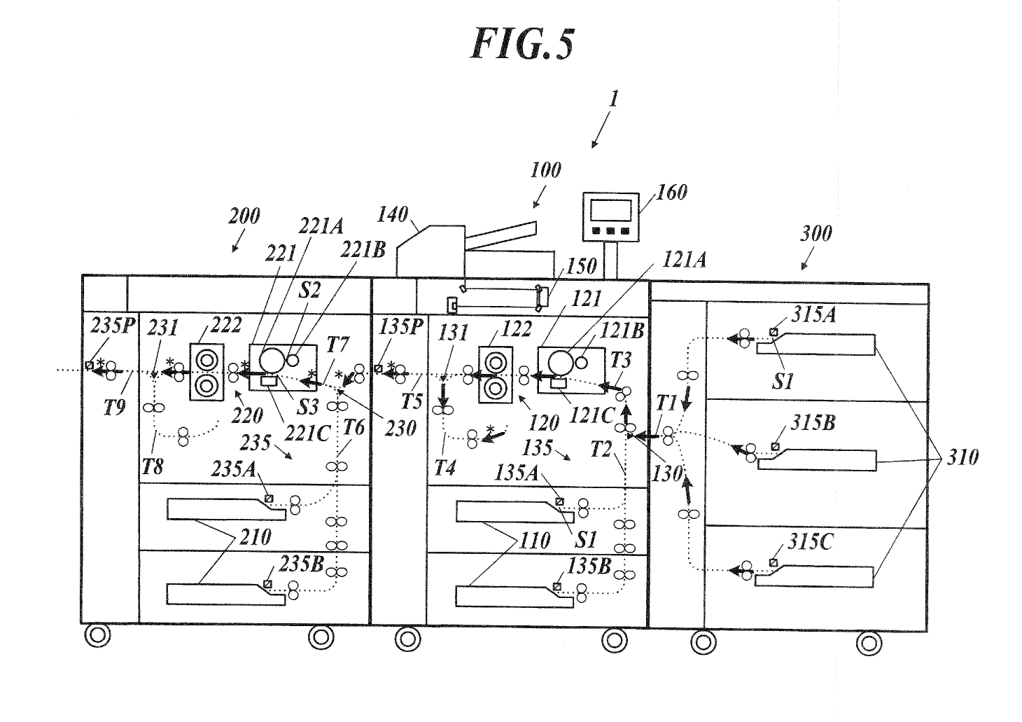

When determining that all sheets to be printed are sheets for both-side printing based upon the print instruction information, the control section 190 executes the double-side print process illustrated in FIG. 5. Solid arrows in FIG. 5 indicate the conveying direction of the sheet during the double-side print process. Arrows with * out of the solid arrows schematically indicate that the back surface of the sheet directs upward.

Specifically, the control section 190 feeds the sheet from one of the feeding unit trays 310 as illustrated in FIG. 5.

In this case, the control section 190 switches, via the first sheet conveying section 132, the conveyance path switching section 130 in order that the sheet through the conveyance path T1 is conveyed to the conveyance path T3. Similarly, the control section 190 switches, via the first sheet conveying section 132, the conveyance path switching section 131 in order that the sheet fed into the conveyance path switching section 131 via the conveyance path T3 is conveyed to the conveyance path T5 via the inverse conveyance path T4.

The control section 190 executes a process of switching the conveyance path changing section 230 in order that the sheet passing through the conveyance path T5 is conveyed to the conveyance path T7 by the second sheet conveying section 232. The control section 190 also executes a control of switching the conveyance path switching section 231 in order that the sheet conveyed to the conveyance path switching section 231 through the conveyance path T7 is conveyed to the conveyance path T9 without passing through the inverse conveyance path T8 by the second sheet conveying section 232.

Next, the control section 190 forms an image based upon the image data for the front surface of the sheet for double-side printing generated by the first image processing section 180, on the single-side of the sheet fed into the conveyance path T3 by the first image forming section 120. Next, the control section 190 conveys the sheet on which the image data for the front surface of the sheet has been formed, to the inverse conveyance path T4. Specifically, the control section 190 allows the sheet to be turned over in order that the sheet is conveyed to the conveyance path T5 with the back surface of the sheet facing upward.

Then, the control section 190 conveys the sheet to the second image forming unit 200 through the conveyance path T5. Next, the control section 190 forms an image based upon image data for the back surface of the sheet for both-side printing, generated by the second image processing section 280, on the back surface of the sheet conveyed to the conveyance path T7 via the conveyance path T5.

The control section 190 conveys the sheet to the finishing unit 400 via the conveyance path T9, executes required finishing processes, and then discharges the resultant sheet on the sheet discharge tray 411.

The control section 190 may naturally execute the double-side print process based upon the sheet fed from one of the feeding trays 110. In this case, the control section 190 switches, via the first sheet conveying section 132, the conveyance path switching section 130 in order that the sheet through the conveyance path T2 is conveyed to the conveyance path T3.

(Case where Sheets to be Printed Include Sheet for Single-Side Printing and Sheet for Both-Side Printing)

When determining that sheets to be printed include both sheets for single-side printing and for both-side printing based upon the print instruction information, the control section 190 executes a mixed print process.

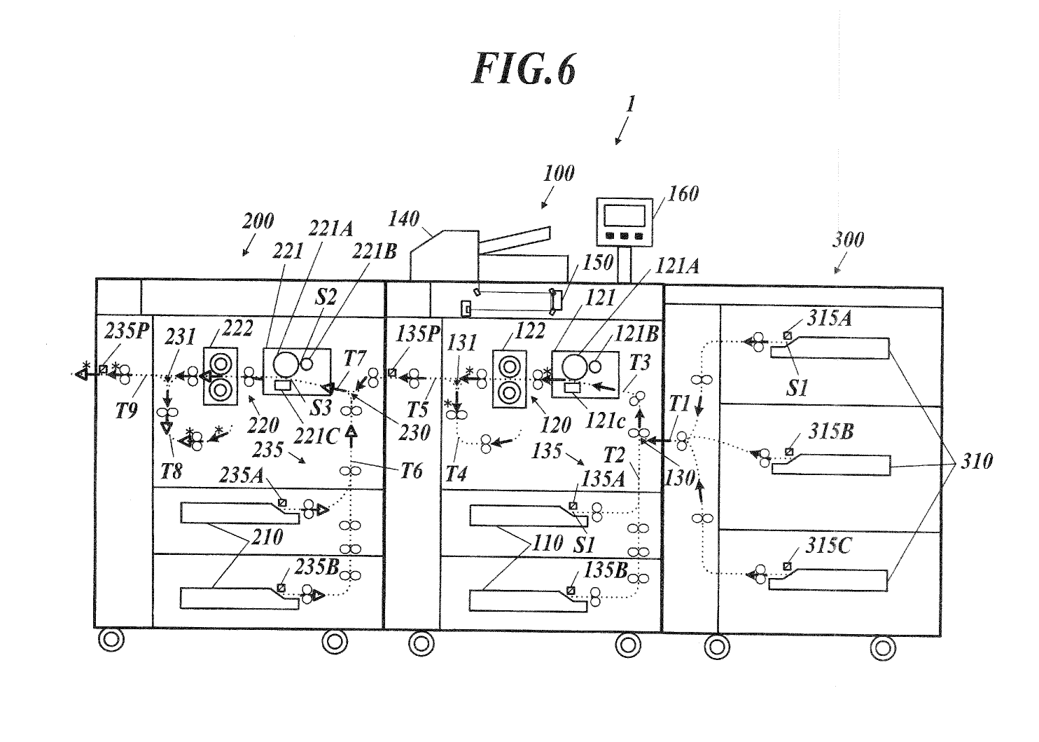

Specifically, when determining that a current page (a sheet to be printed which reaches a timing of executing the print process, out of a plurality of sheets to be printed) is the sheet for single-side printing, the control section 190 executes the single-side print process, while when determining that the current page is the sheet for both-side printing, the control section 190 executes the double-side print process. When the control section 190 executes the double-side print process, it is to be noted that the control section 190 forms an image based upon image data for the back surface of the sheet for both-side printing on a single-side of the sheet conveyed to the conveyance path T3 by the first image forming section 120, as illustrated in FIG. 6.

Then, the control section 190 conveys the sheet, on which the image for the back surface has been formed, to the inverse conveyance path T4, thereby turning over the sheet in order that the sheet is conveyed to the conveyance path T5 with the front surface facing upward. Specifically, the control section 190 forms the image based upon the image data for the front surface of the sheet, on the sheet conveyed to the conveyance path T7 by the second image forming section 220, regardless of the type of the sheet, i.e., the sheet for single-side printing or the sheet for both-side printing. The control section 190 conveys the sheet having the image formed thereon to the inverse conveyance path T8 so as to convey the sheet to the conveyance path T9 with the back surface facing upward.

Accordingly, the control section 190 can always discharge the sheet with the same surface facing upward without changing as to whether the sheet passes through the inverse conveyance path T8 or not by the second sheet conveying section 232 for the case of the current page being the sheet for single-side printing and for the case of the current page being the sheet for both-side printing.

### [Drive State of Image Forming Apparatus During Mixed Print Process]

### (Case Where No-Sheet State is Not Detected)

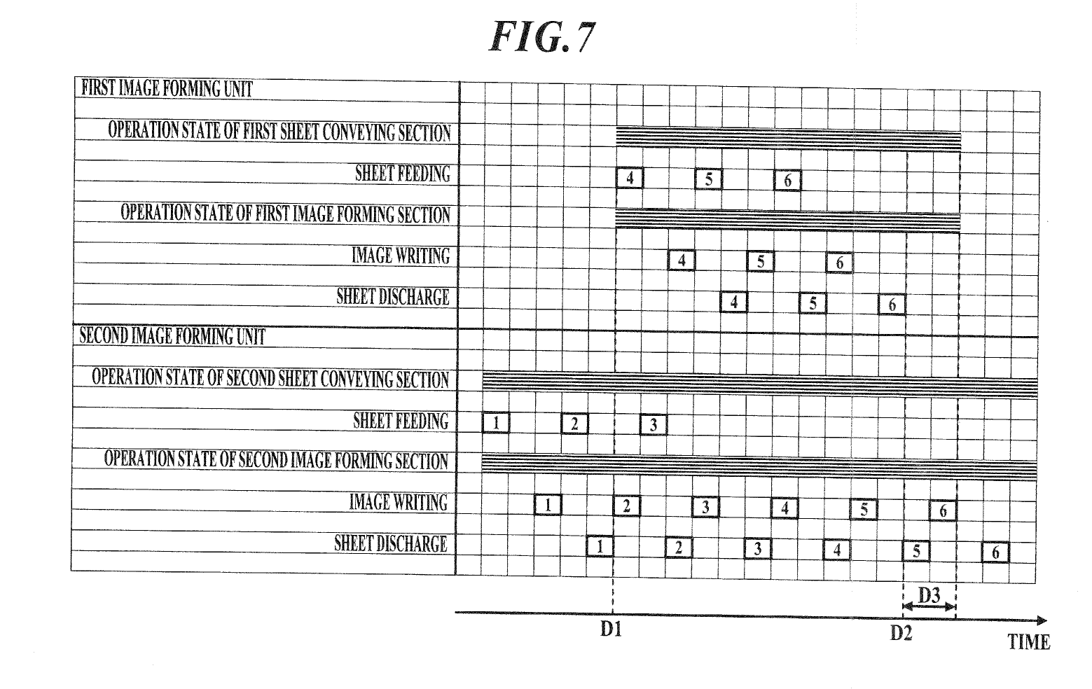

Next, temporal changes in operation states of the image forming apparatus 1 (first image forming unit 100 and the second image forming unit 200) and in execution conditions of the print process for sheets to be printed when the control section 190 executes the mixed print process will be described with reference to a time chart in FIG. 7. FIG. 7 illustrates the case in which the 1st to 3rd sheets to be printed are the sheets for single-side printing, while the 4th to 6th sheets to be printed are the sheets for both-side printing in the print instruction information acquired by the control section 190. It is assumed that, during execution of the print process by the control section 190 based upon the print instruction information, the detection signal indicating that there is no sheet on each tray is not outputted from the feeding unit sensor 315, the first sheet detecting sensor section 135, and the second sheet detecting sensor section 235.

Before the control section 190 starts the print process, the first image forming unit 100 (the first sheet conveying section 132 and the first image forming section 120) and the second image forming unit 200 (the second sheet conveying section 232 and the second image forming section 220) are stopped (are in the stopped state).

The control section 190 starts to drive the second image forming unit 200 (the second sheet conveying section 232 and the second image forming section 220) (brings the second image forming unit 200 into a driven state) through a not-shown power source section or the like in order to execute the single-side print process to the 1st to 3rd sheets to be printed. When executing the single-side print process, the control section 190 does not use the first image forming unit 100. Therefore, the control section 190 continues the stopped state of the first image forming unit 100.

The “stopped state” means a state same as an idling state where the print operation is not executed. Specifically, the stopped state is a state where the drive load for conveying the sheet and the drive load for forming the image, such as the photosensitive drum, are stopped, a high pressure or a laser for forming the image is turned off, and a temperature is controlled with a set temperature during the idling for the fixing operation.

The control section 190 then successively executes the single-side print process (sheet-feeding by the second image forming unit 200, writing of an image, and sheet-discharging from the second image forming unit 200) for the 1st to 3rd sheets to be printed. In this case, the control section 190 switches the operation state of the first image forming unit 100 into the driven state at the point when the writing of the image on the Nth sheet to be printed from the last sheet of the sheets for single-side printing (at the timing of writing the image on the sheet during the single-side print process at a predetermined number of times before the last process), and then starts to feed the 4th sheet to be printed (sheet for both-side printing). Specifically, when N is defined as 1 in FIG. 7, the control section 190 switches the operation state of the first image forming unit 100 to the driven state at a point D1 of starting the writing of an image to the 2nd sheet to be printed, which is one before the 3rd sheet to be printed which is the last sheet of the sheets for single-side printing.

The control section 190 determines the value of N based upon the length of the conveyance path of the sheet from the position S1 where the sheet (sheet for double-side printing) is started to be fed from the first feeding tray 110 or the feeding unit tray 310 to the writing position S2 where an image is written on the photosensitive drum 221A in the second image forming section 220. In other words, the control section 190 determines the value of N according to the number of sheets which can be arranged along the length of β-α of the conveyance path and a predetermined margin number of sheets, when the length of the conveyance path between the positions S3 and S2 is defined as α, and the length of the conveyance path between the positions S3 to S1 is defined as β. When determining that the number of the sheets for single-side printing does not reach N at the point of acquiring the print instruction information, the control section 190 switches the operation state of the first image forming unit 100 to the driven state at the point of starting the print process based upon the print instruction information.

Specifically, when executing the mixed print process, the control section 190 controls the timing of switching the operation state of the first image forming unit 100 according to the execution condition of the single-side print process (e.g., how many print-subject sheets there are for which the single-side print process is completed before the sheet to which the single-side print process is not completed).

Next, the control section 190 executes the double-side print process for the 4th to 6th sheets to be printed, i.e., sequentially executes the print process for the back surface by the first image forming unit 100 (sheet-feeding by the first image forming unit 100, the image formation, sheet-discharging from the first image forming unit 100, image formation by the second image forming unit 200, and sheet-discharging from the second image forming unit 200). The first image forming unit 100 does not have to continue the driven state at the point of detecting the discharge of the last sheet (the 6th sheet to be printed in FIG. 7) of the sheets for both-side printing by the first sheet discharge sensor 135P. Therefore, the control section 190 switches the operation state of the first image forming unit 100 (the first sheet conveying section 132 and the first image forming section 120) to the stopped state at the timing when a predetermined time D3 has elapsed from a point D2 when the discharge of the last sheet of the sheets for both-side printing is detected, as illustrated in FIG. 7.

### (Case Where No-Sheet State is Detected)

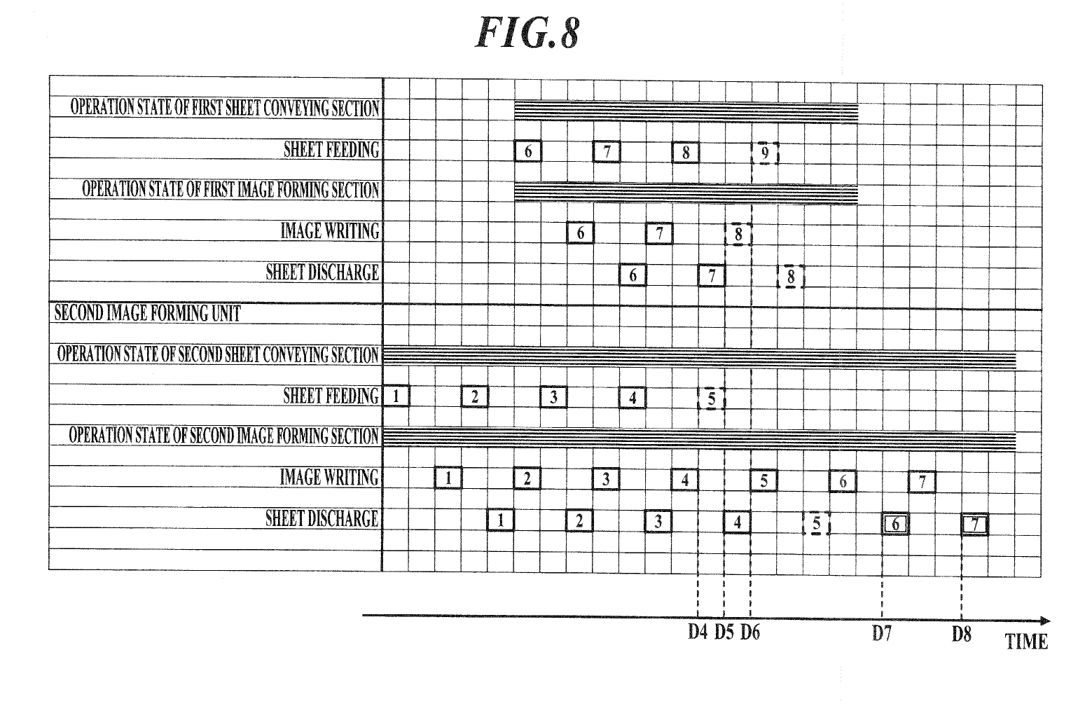

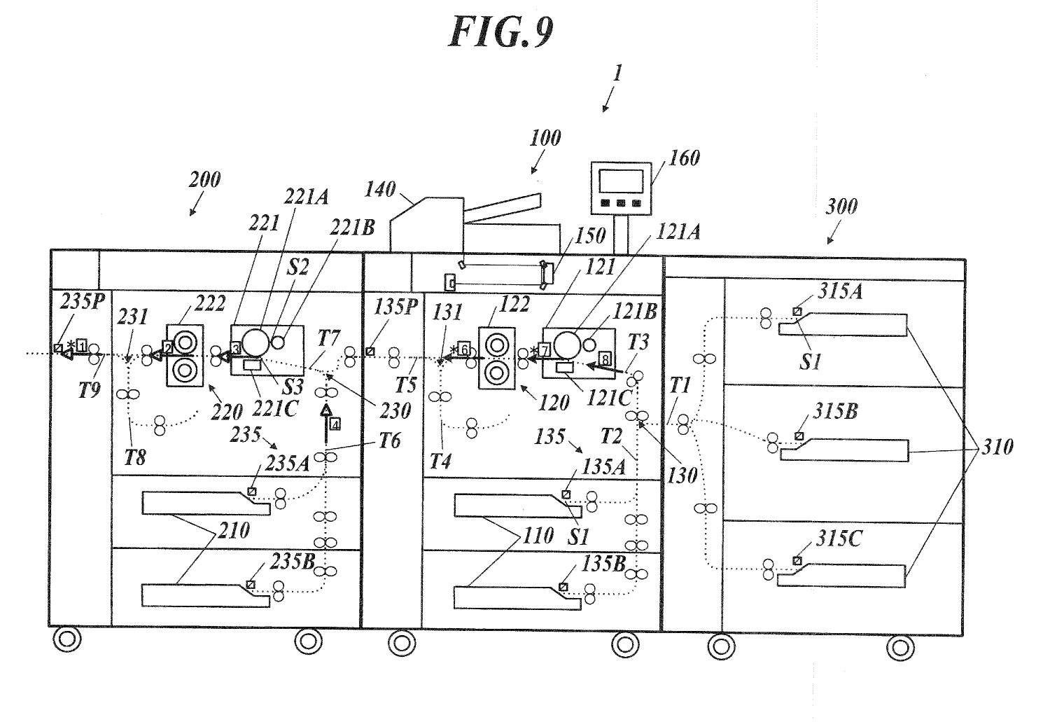

Subsequently, a process executed by the control section 190 when a detection signal indicating that there is no sheet on each tray is outputted during the execution of the mixed print process will be described with reference to FIGS. 8 and 9. FIGS. 8 and 9 illustrate the case in which it is assumed that the 1st to 5th sheets to be printed are sheets for single-side printing, while the 6th to 10th sheets to be printed are sheets for both-side printing based upon the print instruction information acquired by the control section 190. It is also assumed that, when the control section 190 executes the single-side print process, the detection signal indicating that there is no sheet (the 5th sheet to be printed is absent) is outputted from the second sheet detecting sensor section 235 at a point of D4 in FIG. 8. Each numeral written in a rectangle attached to each arrow in FIG. 9 indicates the page number of each sheet to be printed.

Firstly, as in FIG. 7, the control section 190 brings the second image forming unit 200 into a driven state through a not-shown power source or the like in order to execute the single-side print process for the 1st to 5th sheets to be printed. When executing the single-side print process, the control section 190 does not use the first image forming unit 100. Therefore, the control section 190 continues the stopped state of the first image forming unit 100.

Then, the control section 190 sequentially executes the single-side print process for the 1st to 4th sheets to be printed by the second image forming unit 200. In this case, as illustrated in FIG. 8, the control section 190 defines N as 3, and switches the operation state of the first image forming unit 100 into the driven state at the point when the writing of the image on the 2nd sheet, which is the Nth sheet from the 5th sheet that is the last page of the sheets for single-side printing, is started. The control section 190 then sequentially starts the double-side print process for the sixth sheet and the subsequent sheets after the 6th sheet by the first image forming unit 100 as illustrated in FIG. 9.

When the detection signal indicating that there is no sheet in the second feeding tray 210 is outputted from the second sheet detecting sensor section 235 at the point of D4 in FIG. 8, the control section 190 stops the double-side print process by the first image forming unit 100 after the point of D4. Specifically, the control section 190 stops the writing of the image on the 8th sheet to be printed which has already been fed from the first feeding tray 110 at the point of D5 in FIG. 8, and stops the feeding of the 9th sheet to be printed (which has not yet been fed) from the first feeding tray 110 at the point of D6 in FIG. 8.

In this case, as illustrated in FIG. 8, the 6th and 7th sheets to be printed have already been discharged from the first image forming unit 100, and conveyed into the second image forming unit 200, at the point of D5. Therefore, the control section 190 performs control to discharge the 6th and 7th sheets to be printed on the second sheet discharge tray 412, not on the first sheet discharge tray 411, illustrated in FIG. 1, at the points of D7 and F8 in FIG. 8 (i.e., at the point when it is detected that the 6th and 7th sheets to be printed are discharged from the second image forming unit 200 by the detection signal from the second sheet discharge sensor 235P).

The control section 190 may allow the 8th sheet to be printed, for which the writing of the image is stopped at the point of D5, to be discharged on the second sheet discharge tray 412 like the 6th and 7th sheets to be printed, or may allow the 8th sheet to be printed to wait in the conveyance path of the first image forming unit 100 (e.g., at the registration roller provided immediately before the first image forming section 120) until the sheets are supplied to the second feeding tray 210, and then may perform the double-side print process to this sheet as the 6th sheet to be printed at the point when the sheets are supplied.

### (Print Process)

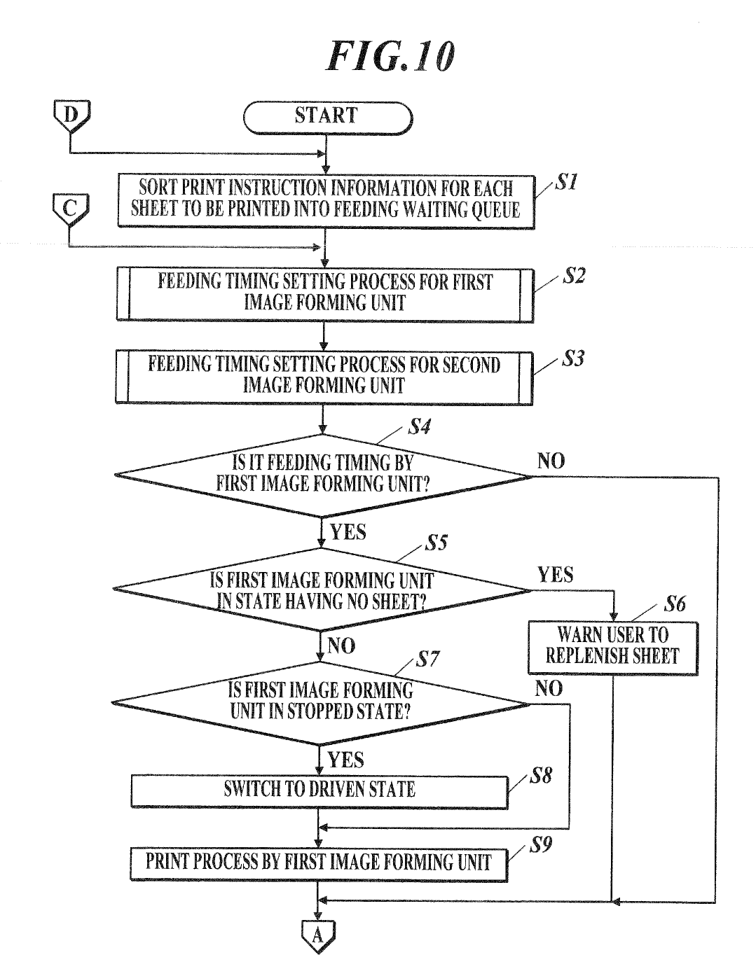

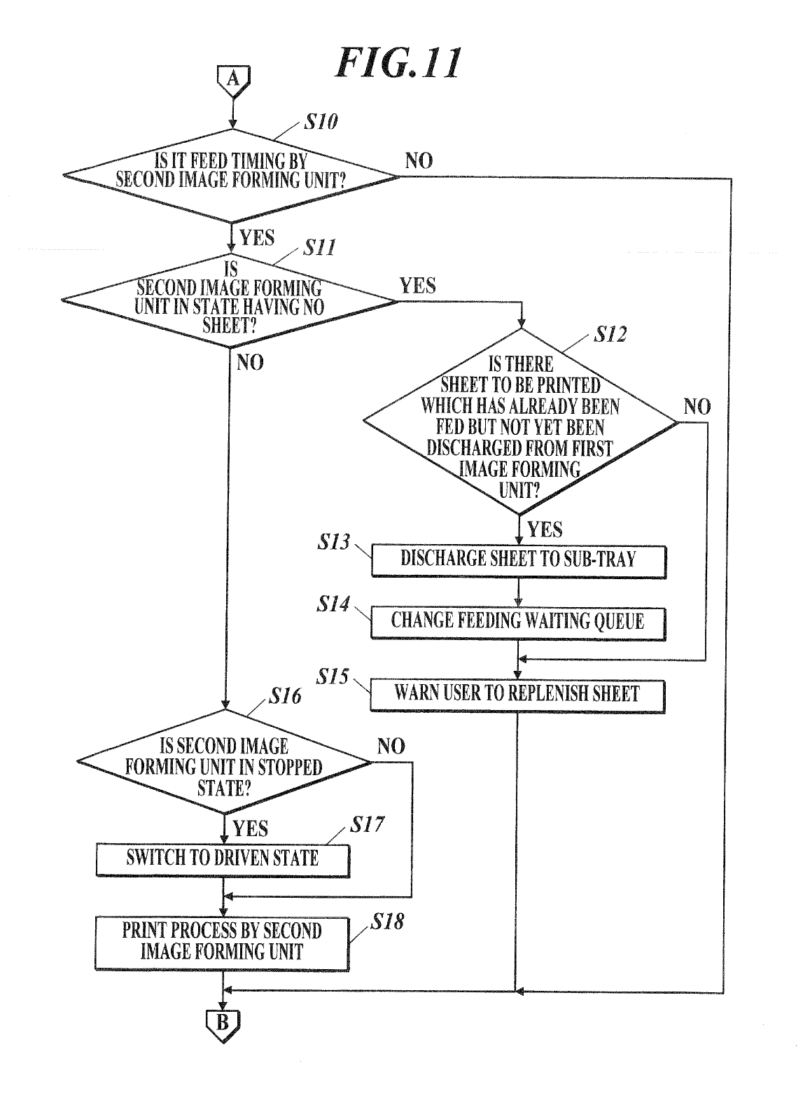

The print process executed by the image forming apparatus 1 according to the present embodiment will be described with reference to flowcharts in FIGS. 10 to 12.

When the print instruction information is acquired, the control section 190 sorts the print instruction information for each sheet to be printed into a feeding waiting queue in the RAM (step S1). The feeding waiting queue is a queue (table) for storing the information, which includes the page number of the sheet to be printed, identification information as to whether the sheet to be printed is the sheet for single-side printing or the sheet for both-side printing, in a unit of a sheet to be printed, and the like.

The control section 190 then executes a later-described feeding timing setting process for the first image forming unit 100 for one of the sheets to be printed (subject page) in the feeding waiting queue (step S2).

Then, the control section 190 executes a later-described feeding timing setting process for the second image forming unit 200 for the subject page (step S3).

The control section 190 then determines whether it is the feeding timing of the subject page by the first image forming unit 100 or not (whether a feeding timing flag according to a later-described step S107 is turned on or not) by the process in step S2 (step S4). When determining that it is not the feeding timing in step S4 (step S4: No), the control section 190 proceeds to step S10.

On the other hand, when determining that it is the feeding timing in step S4 (step S4: Yes), the control section 190 determines whether the first image forming unit 100 is in the state having no sheet or not through the first sheet detecting sensor section 135 (step S5).

When determining that the first image forming unit 100 is in the state having no sheet in step S5 (step S5: Yes), the control section 190 warns a user to replenish sheets through the display operation section 160 (step S6), and then proceeds to step S10. On the other hand, when determining that the first image forming unit 100 is not in the state having no sheet in step S5 (step S5: No), the control section 190 determines whether the first image forming unit 100 is stopped or not (step S7).

When determining that the first image forming unit 100 is not stopped in step S7 (step S7: No), the control section 190 proceeds to a process in step S9. On the other hand, when determining that the first image forming unit 100 is stopped in step S7 (step S7: Yes), the control section 190 switches the operation state of the first image forming unit 100 into the driven state (step S8) so as to execute the print process (the print process for a single-side of the sheet for both-side printing) by the first image forming unit 100 (step S9).

Subsequently, the control section 190 determines whether it is the feeding timing for the subject page by the second image forming unit 200 or not (whether the feeding timing flag according to a later-described step S204 is turned on or not) with the process in step S3 (step S10). When determining that it is not the feeding timing in step S10 (step S10: No), the control section 190 proceeds to a process in step S19.

On the other hand, when determining that it is the feeding timing in step S10 (step S10: Yes), the control section 190 determines whether the second image forming unit 200 is in the state having no sheet or not through the second sheet detecting sensor section 235 (step S11).

When determining that the second image forming unit 200 is in the state having no sheet in step S11 (step S11: Yes), the control section 190 determines whether or not there is the sheet to be printed which has already been fed but not yet discharged from the first image forming unit 100 (whether or not there is a sheet remaining in the first image forming unit 100) (step S12). When determining that there is no subject sheet in step S12 (step S12: No), the control section 190 proceeds to a process in step S15.

On the other hand, when determining that there is the sheet to be printed in step S12 (step S12: Yes), the control section 190 allows the sheet to be printed to be discharged on the second sheet discharge tray 412 of the finishing unit 400 (step S13). Next, the control section 190 changes the feeding waiting queue (increments the page number of the feeding waiting queue according to the number of the discharged sheets in step S13) (step S14).

The control section 190 then warns a user to replenish sheets through the display operation section 160 (step S15), and then, proceeds to step S19.

Subsequently, the control section 190 determines whether the second image forming unit 200 is stopped or not (step S16).

When determining that the second image forming unit 200 is not stopped in step S16 (step S16: No), the control section 190 proceeds to a process in step S18. On the other hand, when determining that the second image forming unit 200 is stopped in step S16 (step S16: Yes), the control section 190 switches the operation state of the second image forming unit 200 into the driven state (step S17) so as to execute the print process (the print process for the sheet for single-side printing) by the second image forming unit 200 (step S18).

The control section 190 then determines whether the sheet to be printed to which the print process has already been performed by the first image forming unit 100 (i.e., the sheet to be printed to which the print process is executed in step S9) is conveyed to the second image forming unit 200 or not (step S19). When determining that it is not conveyed (step S19: No), the control section 190 proceeds to a process in step S21.

On the other hand, when determining that it is conveyed in step S19 (step S19: Yes), the control section 190 executes the print process by the second image forming unit 200 (the print process for the side of the sheet for both-side printing, which side is reverse to the side to which the print process has been executed in step S9) (step S20).

Next, the control section 190 determines whether a predetermined time (the predetermined time D3 illustrated in FIG. 7) has elapsed or not after the last page of the sheets for both-side printing out of the sheets to be printed is discharged (step S21).

When determining that the predetermined time has not elapsed in step S21 (step S21: No), the control section 190 proceeds to a process of step S23. On the other hand, when determining that the predetermined time has elapsed in step S21 (step S21: Yes), the control section 190 switches the operation state of the first image forming unit 100 to the stopped state (step S22).

The control section 190 then determines whether the last page in the feeding waiting queue is discharged or not (whether there are sheets to be printed which are to be fed after the subject page or not) (step S23). When determining that there are the sheets to be printed in step S23 (step S23: Yes), the control section 190 repeats the processes after step S2.

On the other hand, when determining that there is no sheet to be printed in step S23 (step S23: No), the control section 190 determines whether there is another print instruction information or not (whether another print instruction is acquired or not) (step S24). When determining that there is another print instruction information in step S24 (step S24: Yes), the control section 190 repeats the processes after step S1.

On the other hand, when determining that another print instruction information is not present in step S24 (step S24: No), the control section 190 determines whether a predetermined time has elapsed or not after the last page in the feeding waiting queue is discharged (step S25). When determining that the predetermined time has not elapsed (step S25: No), the control section 190 waits until the predetermined time has elapsed. On the other hand, when determining that the predetermined time has elapsed (step S25: Yes), the control section 190 switches the operation state of the second image forming unit 200 to the stopped state (step S26), and then, ends this routine.

### (Feeding Timing Setting Process for First Image Forming Unit)

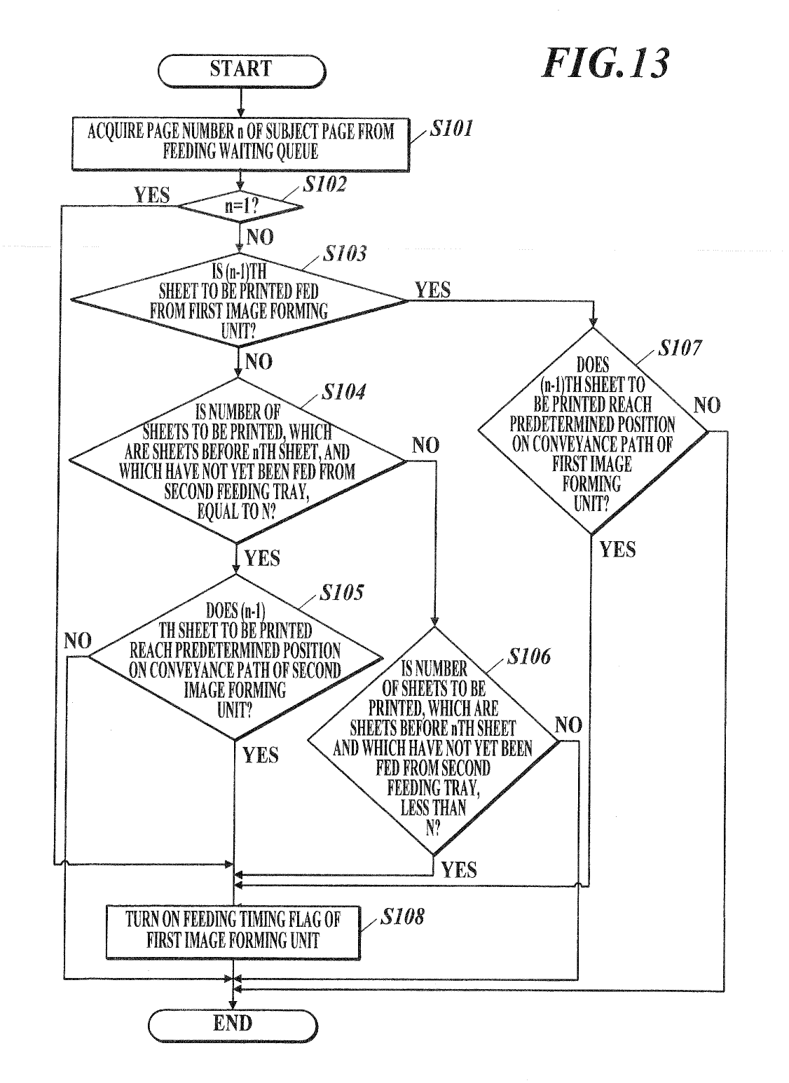

Subsequently, a feeding timing setting process for the first image forming unit 100 executed by the control section 190 will be described with reference to the flowchart in FIG. 13.

Firstly, the control section 190 acquires the page number n of the subject page from the feeding waiting queue (step S101). The control section 190 then determines whether the page number n acquired in step S101 is 1 or not (step S102).

When determining that the page number n is 1 in step S102 (step S102: Yes), the control section 190 proceeds to a process in step S108.

On the other hand, when determining that the page number is not 1 (the page number is greater than 1) in step S102 (step S102: No), the control section 190 determines whether the sheet to be printed having the page number of (n−1) (the sheet to be printed which is the previous sheet from the subject page) is fed from the first image forming unit 100 (or from the feeding unit 300) or not based upon the feeding waiting queue(step S103).

When the control section 190 determines that it is not fed from the first image forming unit 100) (i.e., determines that it has been fed from the second image forming unit 200) in step S103 (step S103: No), the control section 190 determines whether or not the number of sheets to be printed which are before the subject page and which have not yet been fed from the second feeding tray 210 is N or not (step S104).

When determining that the number is N in step S104 (step S104: Yes), the control section 190 determines whether the (n−1)th sheet to be printed reaches the predetermined position on the conveyance path of the second image forming unit 200 via the second sheet detecting sensor section 235 or not (step S105).

When determining that the (n−1)th sheet reaches the predetermined position on the conveyance path in step S105 (step S105: Yes), the control section 190 proceeds to the process in step S108. On the other hand, when determining that the (n−1)th sheet does not reach the predetermined position on the conveyance path in step S105 (step S105: No), the control section 190 ends this routine.

The control section 190 may determine in step S105 whether or not the predetermined time has elapsed or not after the sheet to be printed to which the print process is currently executed is started to be fed from the second feeding tray 210. The control section 190 may set, as the condition for the determination, not only the predetermined time after the start of the feeding but also the timing of conveying the sheet to be printed, the timing of writing the image on the sheet to be printed, or the like.

When determining that N sheets are not present in step S104 (S104: No), the control section 190 determines whether the number of the sheets to be printed which are before the subject page and which have not yet been fed from the second feeding tray 210 is less than N or not (step S106). When determining that the number is less than N in step S106 (step S106: Yes), the control section 190 proceeds to the process in step S108. On the other hand, when determining that the number exceeds N in step S106 (step S106: No), the control section 190 ends this routine.

When determining that the (n−1)th sheet is fed from the first image forming unit 100 in step S103 (step S103: Yes), the control section 190 determines whether the sheet to be printed having the page number of (n−1) reaches the predetermined position on the conveyance path of the first image forming unit 100 through the first sheet detecting sensor section 135 or not (step S107). When determining that the (n−1)th sheet reaches the predetermined position on the conveyance path in step S107 (step S107: Yes), the control section 190 proceeds to the process in step S108. On the other hand, when determining that it does not reach the predetermined position on the conveyance path in step S107 (step S107: No), the control section 190 ends this routine.

When the control section 190 determines that it reaches the predetermined position on the conveyance path in step S105 or in step S107 (step S105, step S107: Yes), or determines that the number is less than N in step S106 (step S106: Yes), it turns on a feeding timing flag indicating that it is the feed timing of the subject page by the first image forming unit 100, (step S108), and then ends this routine.

### (Feeding Timing Setting Process for Second Image Forming Unit)

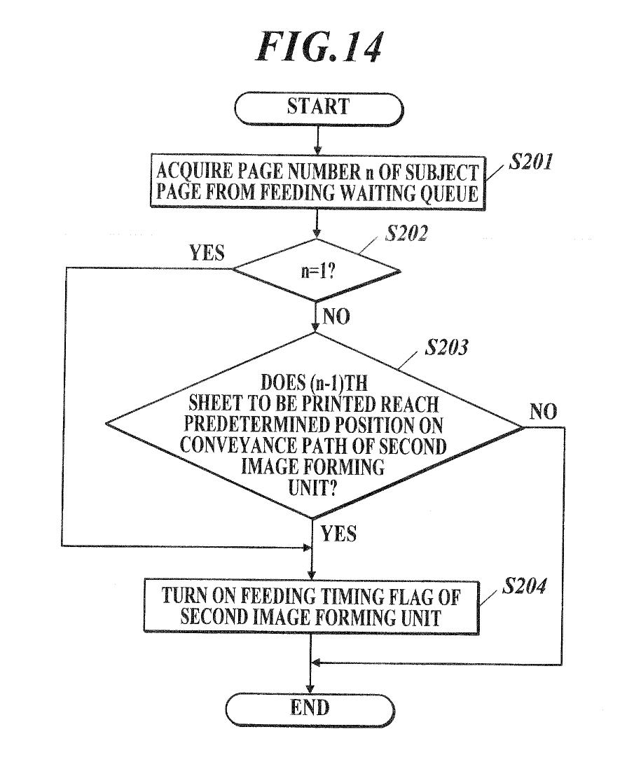

Subsequently, a feeding timing setting process for the second image forming unit 200 executed by the control section 190 will be described with reference to the flowchart in FIG. 14.

Firstly, the control section 190 acquires the page number n of the subject page from the feeding waiting queue (step S201). The control section 190 then determines whether the page number n acquired in step S201 is 1 or not (step S202).

When determining that the page number n is 1 in step S202 (step S202: Yes), the control section 190 proceeds to a process in step S204.

On the other hand, when determining that the page number is not 1 (the page number is greater than 1) in step S202 (step S202: No), the control section 190 determines whether the sheet to be printed having the page number of (n−1) reaches the predetermined position on the conveyance path of the second image forming unit 200 through the second sheet detecting sensor section 235 or not (step S203).

When the control section 190 determines that it reaches the predetermined position on the conveyance path in step S203 (step S203: Yes), it turns on a feeding timing flag indicating that it is the feed timing of the subject page by the second image forming unit 200 (step S204), and then ends this routine. On the other hand, when determining that the (n−1)th sheet does not reach the predetermined position on the conveyance path in step S203 (step S203: No), the control section 190 ends this routine.

According to the image forming apparatus 1 of the present embodiment, when the control section 190 executes the mixed print process based upon the print instruction information, the control section 190 controls the timing of switching the operation state (driven state or stopped state) of the first image forming unit 100 according to the execution condition of the single-side print process indicating how many print-subject sheets there are for which the single-side print process has been completed. Accordingly, even when the control section 190 executes the single-side print process upon executing the mixed print process, unnecessary material deterioration and power consumption of the first image forming unit 100, which are caused because the first image forming unit 100 is always in the driven state, can suitably be prevented.

Consequently, the image forming apparatus 1 can be said to be an image forming apparatus which is constructed while considering the operation state of the image forming unit at the first stage when executing the print process based upon the print instruction information by switching the pattern in which the print process is executed to the sheet fed from the feeding tray provided in the image forming unit at the first stage and the pattern in which the print process is executed to the sheet fed from the feeding tray provided in the image forming unit at the next stage.

When executing the mixed print process of the pattern in which the print process is executed to a plurality of number of sheets for single-side printing and then the print process is executed to the sheet for both-side printing, the control section 190 switches the operation state of the first image forming unit 100 to the driven state from the stopped state at the point of starting the writing of the image on the sheet to be printed, which is the sheet N sheets before the last page of the sheets for single-side printing, and then starts the feeding of the sheet for both-side printing.

Specifically, the control section 190 does not always bring the first image forming unit 100 into the driven state from the point of starting the mixed print process, but brings the first image forming unit 100 into the stopped state before the point of starting the writing of the image, thereby being capable of suppressing unnecessary power consumption by the first image forming unit 100.

It is to be noted that, when the control section 190 determines that the number of the sheets for single-side printing does not reach N, it switches the operation state of the first image forming unit 100 from the stopped state to the driven state, and then starts the feeding of the sheet for both-side printing. Therefore, the control section 190 can secure responsiveness (productivity of sheet for both-side printing) upon the start of the double-side print process in case where the number of the sheets for single-side printing in the mixed print process is small, and therefore, the double-side print process has to be immediately started.

When the control section 190 determines that the second feeding tray 210 has no sheet during the execution of the mixed print process, the control section 190 discharges the sheet to be printed (the sheet which is not discharged on the first sheet discharge tray 411) which has already been fed from the first image forming unit 100 and which is the sheet of the page at which the no-sheet state is detected, or is the subsequent sheets thereto, is discharged on the second sheet discharge tray 412 as a waste sheets.

Accordingly, the control section 190 can prevent the effect to the final output of all sheets to be printed (the page number upon the discharge is out of order, and the other situation), which is caused by the discharge of the sheet to be printed, which has already been fed from the first image forming unit 100 regardless of the no-sheet state, on the sheet discharge tray 411.

The control section 190 allows the sheet to be printed on which the image is not written by the first image forming unit 100, out of the sheets to be printed which have already been fed from the first image forming unit 100 and which is the sheet of the page at which the no-sheet state is detected or the subsequent sheets thereto, to be waited in the conveyance path in the first image forming unit 100. The control section 190 executes the writing of the image on the sheet to be printed, when sheets are replenished by a user.

Specifically, the control section 190 can prevent the unnecessary discharge of the sheet to be printed, on which the image is not written, on the first sheet discharge tray 411, whereby the productivity to the final output of all sheets to be printed can be enhanced.

### (First Modification)

In the first embodiment, when executing the mixed print process illustrated in FIG. 7, the control section 190 switches the operation state of the first image forming unit 100 to the driven state from the stopped state at the time of starting the writing of the image on the sheet to be printed, which is the sheet N sheets before the last sheet of the sheets for single-side printing.

In this regard, when the number of the sheets for single-side printing in the print instruction information is less than the predetermined number, the control section 190 may bring the first image forming unit 100 into the driven state at the time of starting the mixed print process, and when the number of the sheets for single-side printing exceeds the predetermined number, the control section 190 may bring the first image forming unit 100 into the stopped state upon starting the mixed print process.

### (Second Modification)

The control section 190 may also be configured as described below. Specifically, for example, the control section 190 may calculate (predict) the time required for the print process for the sheets for single-side printing based upon the number of the sheets for single-side printing and the time after the second feeding tray 210 feeds the sheet and before the sheet is discharged from the second image forming unit 200. When the time does not reach a predetermined time, the control section may bring the first image forming unit 100 into the driven state at the point of starting the mixed print process. When the time exceeds the predetermined time, the control section may bring the first image forming unit 100 into the stopped state at the point of starting the mixed print process.

Specifically, the control section 190 according to the modifications 1 and 2 changes the operation state of the first image forming unit 100 between the driven state and the stopped state at the point of starting the mixed print process according to the number of the sheets for single-side printing and the time required for the print process for the sheets for single-side printing. Therefore, the control section can suppress unnecessary power consumption by the first image forming unit 100.

### (Third Modification)

In the first embodiment, FIGS. 7 and 8 illustrate the pattern in which the plurality of sheets for both-side printing are present after the plurality of sheets for single-side printing in the print instruction information. However, as in the third modification, there is a pattern in which the plurality of sheets for single-side printing are present after the plurality of sheets for both-side printing, and then the plurality of sheets for both-side printing are present after the the plurality of sheets for single-side printing (i.e., the control section 190 executes the single-side print process after the double-side print process, and then executes the double-side print process).

In this case, the control section 190 controls the drive state of the first image forming unit 100 according to the number of the sheets for single-side printing (the number of times of the execution of the single-side print process). Specifically, the control section 190 counts the number of the sheets for single-side printing based upon the acquired print instruction information. When the counted number of the sheets for single-side printing is less than the predetermined number, the control section 190 keeps driving the first image forming unit 100, which is in the driven state during the first double-side print process, during the execution of the single-side print process. On the other hand, when the counted number exceeds the predetermined number, the control section 190 stops the first image forming unit 100, which is in the driven state in the first double-side print process, during the execution of the single-side print process.

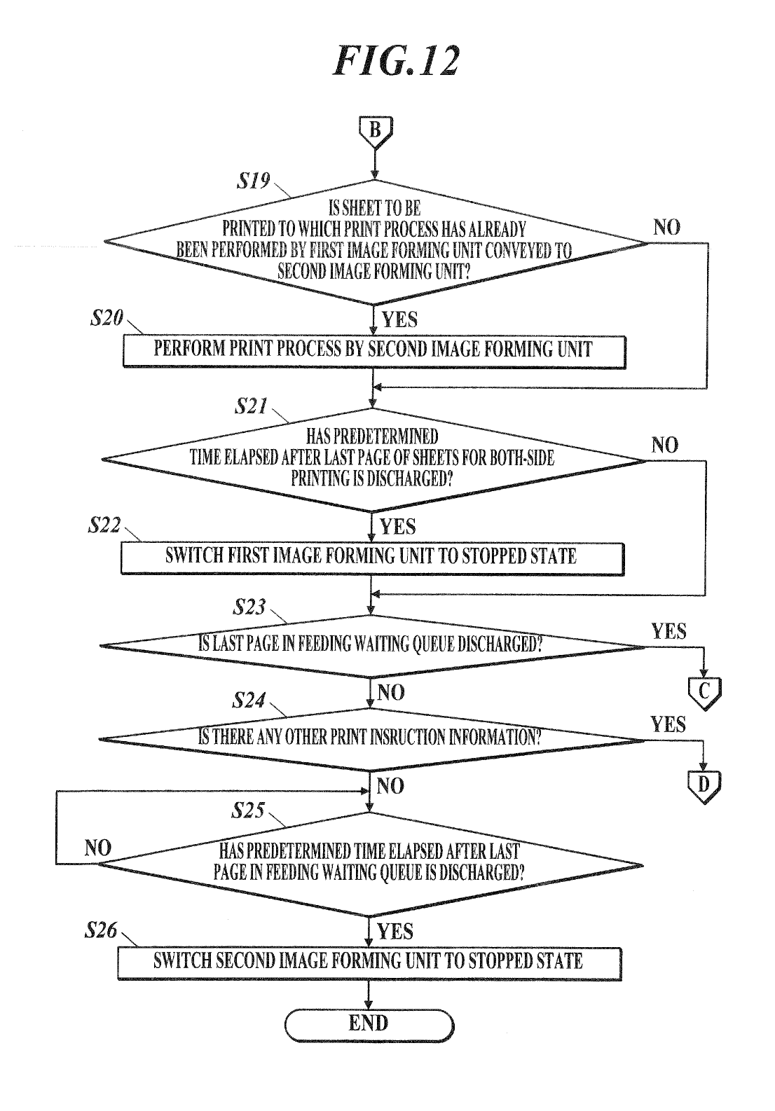

When executing the print process explained with reference to the flowcharts in FIGS. 10 to 12, the control section 190 performs processes described below instead of steps S21 and S22 illustrated in FIG. 12. Specifically, the control section 190 determines whether the drive of the first image forming unit 100 is continued or stopped according to whether or not the counted number of the sheets for single-side printing is less than the predetermined number. Based upon the result of the determination, the control section 190 controls the timing of driving the first image forming unit 100.

As described above, according to the present modification, when the time of the execution of the single-side print process is expected to be short in case where the control section 190 executes the single-side print process after the execution of the double-side print process, and then executes the double-side print process, the control section 190 keeps driving the first image forming unit 100, whereby the responsiveness (productivity for the sheets for both-side printing) upon the start of the double-side print process afterward can be enhanced. On the other hand, when the time of the execution of the single-side print process is expected to be sufficiently long, the control section 190 stops the first image forming unit 100, which can attain power saving of the image forming apparatus 1.

In the third modification, the control section 190 controls the drive state of the first image forming unit 100 according to the number of the sheets for single-side printing (the number of times of the execution of the single-side print process). However, it may naturally be configured as described below. Specifically, the time taken for continuously executing the first single-side print process may be calculated. When the calculated time is less than a predetermined time, the control section 190 may keep the drive of the first image forming unit 100. On the other hand, when the calculated time exceeds the predetermined time, the control section 190 may stop the first image forming unit 100.

The description for the above-mentioned embodiment is only illustrative of a preferable image forming apparatus according to the present invention, and the invention is not limited thereto.

The detailed configurations and detailed operations of the respective sections constituting the image forming apparatus according to the above-mentioned embodiment can appropriately be modified without departing from the scope of the present invention.

Specifically, the image forming apparatus 1 may have a configuration in which the feeding unit 300, the first image forming unit 100, the second image forming unit 200, and the finishing unit 400 are separately provided, and each of the units is connected. Alternatively, these units may be integrally formed.

According to the present embodiment, there is provided an image forming apparatus including: a first image forming unit provided at a first stage for executing a print process to a single-side of a sheet, the first image forming unit including a first feeding tray for feeding a sheet; and a second image forming unit provided at a next stage for executing a print process to a single-side of a sheet, the second image forming unit including a second feeding tray for feeding a sheet, and the first and second image forming units being connected in series so as to execute a print process on the single-side or a both-sides of the sheet, wherein the image forming apparatus further including a control section which is adapted to, when a first print process with respect to the sheet fed from the first feeding tray and a second print process with respect to the sheet fed from the second feeding tray are switched based upon print instruction information for instructing execution of the print process on the single-side or the both-sides for each sheet to be printed so as to execute the switched print process, control an operation state of the first image forming unit depending on an execution condition of the second print process.

Preferably, when the control section executes the second print process after executing the first print process and then further executes the first print process based upon the print instruction information, the control section keeps the first image forming unit driving even during the second print process in case where the number of times of continuous execution of the second print process for continuously forming images on a plurality of sheets becomes less than a predetermined number of time, while the control section stops the first image forming unit during the second print process in case where the number of times of the continuous execution of the second print process exceeds the predetermined number of times.

Preferably, when the control section executes the second print process after executing the first print process and then further executes the first print process based upon the print instruction information, the control section keeps the first image forming unit driving even during the second print process in case where the control section calculates a time taken for continuously executing the second print process and the calculated time becomes less than a predetermined time, while the control section stops the first image forming unit during the second print process in case where the calculated time exceeds the predetermined time.

Preferably, when the control section executes the first print process after continuously executing the second print process in a plurality of times in order to continuously form images on a plurality of sheets based upon the print instruction information, the control section starts driving the first image forming unit and starts feeding a sheet from the first feeding tray in the first print process at a timing of writing the image in the second print process predetermined number of times before the last second print process.

Preferably, when the control section executes the first print process after continuously executing the second print process in a plurality of times in order to continuously form images on a plurality of sheets based upon the print instruction information, in case where the plurality of times is less than a predetermined number of times, the control section starts driving the first image forming unit and starts feeding a sheet from the first feeding tray in the first print process at a timing of starting the second print process.

Preferably, the image forming apparatus further includes: a first sheet discharge tray on which a sheet is discharged, to which sheet the first print process or the second print process has been executed by the control section; and a second sheet discharge tray on which a sheet is discharged and which is different from the first sheet discharge tray, and when the control section determines that there is no sheet in the second feeding tray during the second print process, the control section allows the sheet, which has already been fed from the first feeding tray and has not yet been discharged on the first sheet discharge tray, to be discharged on the second sheet discharge tray at the point when the control section determines that there is no sheet on the second feeding tray.

Preferably, the image forming apparatus further includes: a first sheet discharge tray on which a sheet is discharged, to which sheet the first print process or the second print process has been executed by the control section; and a second sheet discharge tray on which a sheet is discharged and which is different from the first sheet discharge tray, and when the control section determines that there is no sheet in the second feeding tray during the second print process, the control section allows the sheet, on which the image is written by the first print process, out of sheets which have already been fed from the first feeding tray and have not yet been discharged on the first sheet discharge tray, to be discharged on the second sheet discharge tray, while the control section allows a sheet on which the image is not written by the first print process to be waited in a conveyance path provided in the first image forming unit at the point when the control section determines that there is no sheet on the second feeding tray.

According to the present invention, the operation of the image forming unit at the first stage is controlled, when the pattern in which the print process is executed to the sheet fed from the feeding tray provided in the image forming unit at the first stage and the pattern in which the print process is executed to the sheet fed from the feeding tray provided in the image forming unit at the next stage are switched to execute the print process based upon the print instruction information, whereby a material deterioration of the first image forming unit is prevented, and the power consumption of the image forming apparatus can be suppressed.

The present U.S. patent application claims a priority under the Paris Convention of Japanese patent application No. 2010-280408 filed on Dec. 16, 2010, in which all contents of this application are disclosed, and which shall be a basis of correction of an incorrect translation.

What is claimed is:

1. An image forming apparatus comprising:
a first image forming unit provided at a first stage for executing a print process to a single-side of a sheet, the first image forming unit including a first feeding tray for feeding a sheet; and
a second image forming unit provided at a next stage for executing a print process to a single-side of a sheet, the second image forming unit including a second feeding tray for feeding a sheet, and the first and second image forming units being connected in series so as to execute a print process on the single-side or a both-sides of the sheet,
wherein the image forming apparatus further including a control section which is adapted to, when a first print process with respect to the sheet fed from the first feeding tray and a second print process with respect to the sheet fed from the second feeding tray are switched based upon print instruction information for instructing execution of the print process on the single-side or the both-sides for each sheet to be printed so as to execute the switched print process, control an operation state of the first image forming unit depending on an execution condition of the second print process.

2. The image forming apparatus of claim 1, wherein when the control section executes the second print process after executing the first print process and then further executes the first print process based upon the print instruction information, the control section keeps the first image forming unit driving even during the second print process in case where the number of times of continuous execution of the second print process for continuously forming images on a plurality of sheets becomes less than a predetermined number of time, while the control section stops the first image forming unit during the second print process in case where the number of times of the continuous execution of the second print process exceeds the predetermined number of times.

3. The image forming apparatus of claim 1, wherein when the control section executes the second print process after executing the first print process and then further executes the first print process based upon the print instruction information, the control section keeps the first image forming unit driving even during the second print process in case where the control section calculates a time taken for continuously executing the second print process and the calculated time becomes less than a predetermined time, while the control section stops the first image forming unit during the second print process in case where the calculated time exceeds the predetermined time.

4. The image forming apparatus of claim 1, wherein when the control section executes the first print process after continuously executing the second print process in a plurality of times in order to continuously form images on a plurality of sheets based upon the print instruction information, the control section starts driving the first image forming unit and starts feeding a sheet from the first feeding tray in the first print process at a timing of writing the image in the second print process predetermined number of times before the last second print process.

5. The image forming apparatus of claim 1, wherein when the control section executes the first print process after continuously executing the second print process in a plurality of times in order to continuously form images on a plurality of sheets based upon the print instruction information, in case where the plurality of times is less than a predetermined number of times, the control section starts driving the first image forming unit and starts feeding a sheet from the first feeding tray in the first print process at a timing of starting the second print process.

6. The image forming apparatus of claim 4, further comprising:
a first sheet discharge tray on which a sheet is discharged, to which sheet the first print process or the second print process has been executed by the control section; and
a second sheet discharge tray on which a sheet is discharged and which is different from the first sheet discharge tray,
wherein when the control section determines that there is no sheet in the second feeding tray during the second print process, the control section allows the sheet, which has already been fed from the first feeding tray and has not yet been discharged on the first sheet discharge tray, to be discharged on the second sheet discharge tray at the point when the control section determines that there is no sheet on the second feeding tray.

7. The image forming apparatus of claim 4, further comprising:
a first sheet discharge tray on which a sheet is discharged, to which sheet the first print process or the second print process has been executed by the control section; and
a second sheet discharge tray on which a sheet is discharged and which is different from the first sheet discharge tray,
wherein when the control section determines that there is no sheet in the second feeding tray during the second print process, the control section allows the sheet, on which the image is written by the first print process, out of sheets which have already been fed from the first feeding tray and have not yet been discharged on the first sheet discharge tray, to be discharged on the second sheet discharge tray, while the control section allows a sheet on which the image is not written by the first print process to be waited in a conveyance path provided in the first image forming unit at the point when the control section determines that there is no sheet on the second feeding tray.
